(19) United States
(12) Patent Application Publication
(10) Pub. No.: US 2007/0206500 A1
(43) Pub. Date: Sep. 6, 2007

(54) METHOD AND APPARATUS FOR BEACON TRANSMISSION WITHIN A MULTI HOP COMMUNICATION SYSTEM

(75) Inventors: Mohsin M. Mollah, Chiba-shi (JP); Masahito Asa, Katsushika-ku, Tokyo (JP); David T. Chen, Palatine, IL (US); Ryutaro Hamasaki, higashikurume-shi, Tokyo (JP); Tetsu Ikeda, Kawasaki, Kanagawa (JP)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/276,488

(22) Filed: Mar. 2, 2006

(51) Int. Cl. H04J 1/16; H04J 3/08

(52) U.S. Cl. 370/235; 370/315

(57) ABSTRACT

A base station (101) will instruct relay stations (102) to periodically skip transmissions of their control information when control messaging by all relay stations exceeds a predetermined threshold (e.g., 50% of radio resource capacity). The base station determines the relay stations to skip by periodically ranking the relay stations and skipping control messages for relay stations having a lowest rank.

### FIELD OF THE INVENTION

The present invention relates generally to transmitting control information within a communication system and in particular, to a method and apparatus for beacon transmission within a multi-hop communication system.

### BACKGROUND OF THE INVENTION

Multi-hop communication systems typically consist of a root node (sometimes referred to as a base station (BS)) in communication with multiple relay stations (RS) and mobile stations(MS). During operation, relay stations are utilized to increase the range of a base station, essentially decoding the base station's transmissions and scheduling/retransmitting to those mobile stations outside the base station's transmission range. In a centralized multi-hop communication system or a cellular communication system, a large radio resource is required for transmitting control message from base stations and relay stations when large number of relay stations are deployed to cover an area. More particularly, all base stations and relay stations transmit a beacon once per frame with a beacon message announcing their logical address, depth, and additional optional descriptive information (for example, if it accepts children, location coordinates, . . . , etc). Because of the large amount of potential transmission, radio resources available for data transmission are limited. Therefore, a need exists for a method and apparatus for transmitting beacons within a multi-hop communication system that minimizes radio resources used.

### BRIEF DESCRIPTION OF THE DRAWINGS

FIG. 1 is a block diagram of a communication system.

FIG. 2 illustrates control message transmission for the communication system of FIG. 1.

FIG. 3 is a block diagram of a base station.

FIG. 4 is a flow chart showing operation of the base station of FIG. 3.

FIG. 5 is additional flow chart showing operation of the base station of FIG. 3

### DETAILED DESCRIPTION OF THE DRAWINGS

In order to address the above-mentioned need, a method and apparatus for broadcasting information within a multi-hop communication system is provided herein. During operation a base station will instruct relay stations to skip transmissions of their control information when control messaging by all relay stations exceeds a predetermined threshold (e.g., 50% of radio resource capacity). The base station determines the relay stations to skip by periodically ranking relay stations and skipping control message transmissions for relay stations having a lowest rank. The base station additionally keeps the record of relay stations that have been skipped to prevent skipping a particular station multiple times, which may cause service disruptions.

The present invention encompasses a method for beacon transmission. The method comprises the steps of determining resources required by beacon transmissions, determining if the resources required exceeds a threshold, and rank ordering relay stations. Relay station(s) having a low rank are instructed to cease beacon transmission.

The present invention additionally encompasses a method for beacon transmission. The method comprises the steps of determining resources required by beacon transmissions, determining if the resources required exceeds a threshold, and determining a skipping rate for relay stations. Relay stations are instructed to cease beacon transmission based on the skipping rate.

The present invention additionally encompasses an apparatus comprising logic circuitry determining resources required by beacon transmissions, determining if the resources required exceeds a threshold, rank ordering relay stations. The apparatus comprises a transmitter instructing a relay station having a low rank to cease beacon transmission.

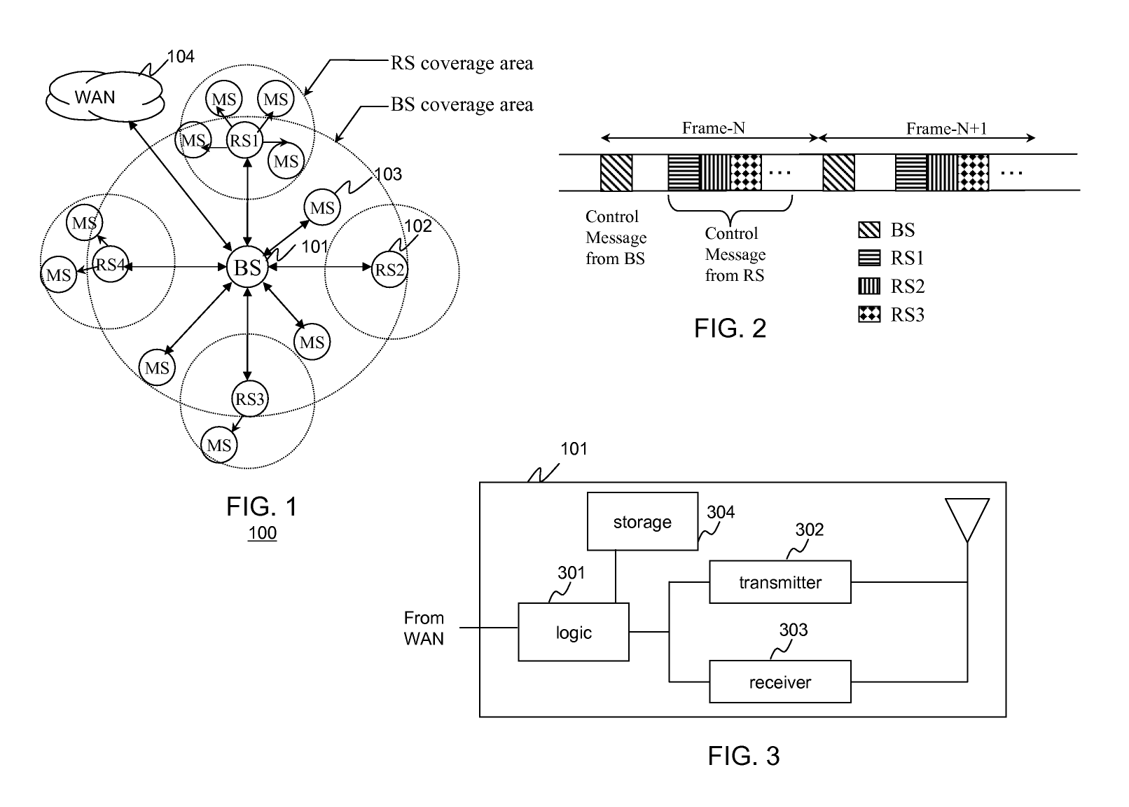

Turning now to the drawings, wherein like numerals designate like components, FIG. 1 is a block diagram of communication system 100. Communication system 100 preferably utilizes a wireless metropolitan area network protocol defined by the IEEE 802.16 communication system protocol. However, in alternate embodiments of the present invention, other communication system protocols may be utilized by communication system 100. These other communication system protocols include, but are not limited to, IEEE 802.15.3 Wireless Personal Area Networks for High Data Rates, IEEE 802.15.4 Low Rate Wireless Personal Area Networks, Bluetooth™ standard (IEEE Standard 802.15.1), . . . , etc.

As shown, communication system 100 includes base station (root node) 101 in communication with multiple relay stations 102 and mobile stations 103 (only one relay station 102 and mobile station 103 are labeled). Base station 101 acts as a communication hub for users of wireless devices (mobile stations 103) to connect to wide-area network (WAN) 104. All mobile stations 103 preferably access WAN 104 by communicating via transmissions over an RF communication channel through base station 101. It is contemplated that network elements within communication system 100 are configured in well known manners with processors, memories, instruction sets, and the like, which function in any suitable manner to perform the function set forth herein.

As discussed, relay stations 102 are utilized to increase the range of base station 101, essentially retransmitting the base station's transmissions to those mobile stations 103 outside the base station's transmission range. Base station 101 and relay station 102 typically transmit a beacon (control information) once per frame. This is illustrated in FIG. 2. As shown in FIG. 2, base station 101 and all relay stations 102 will broadcast control information once per frame. Because of this, radio resources available for data transmission can become limited.

In order to address this issue, base station 101 will instruct relay stations 102 to periodically skip transmissions of their control information when control messaging by all relay stations 102 exceeds a predetermined threshold (e.g., a percentage of radio resource capacity). Base station 101 determines the relay stations to skip by periodically ranking relay stations 102 and skipping control messages for relay stations 102 having a lowest rank. Base station 101 additionally keeps the record of relay stations 102 that have been skipped to prevent skipping too many control messages, which may cause service disruptions.

In a first embodiment of the present invention, relay stations 102 are ranked based on a quality of service required by connected mobile stations 103. Thus, in the first embodiment of the present invention, base station 101 determines those relay stations in communication with at least one mobile station 103 having a high quality of service requirement. These relay stations 102 will then be ranked high. Similarly, those relay stations 102 currently communicating with nodes having a mid-tier quality of service will be ranked lower than relay stations 102 in communication with nodes having a high quality of service. Finally, those relay stations 102 in communication only with mobile stations 103 having a low quality of service requirement will be ranked low.

In alternate embodiments of the present invention, ranking of relay stations 102 may be based on other criteria such as statistic information. For example, relay stations that have a larger number of registered (attached) mobile stations compared to other relay stations may be ranked as high. Alternatively, a probability to relay the communication between a base station and mobile stations could be used to make a relay station rank higher, with higher probability of relaying capable relay stations being ranked higher. Additionally, a relay station that may have a higher probability to have a new registration of mobile stations could be ranked as high.

FIG. 3 is a block diagram of base station 101. As shown, base station 101 comprises logic circuitry 301, transmit circuitry 302, receive circuitry 303, and storage (database) 304. Storage 304 serves to store a list of relay stations 102 along with their rankings. Storage 304 additionally serves to store a list of relay stations that had their beacon transmissions skipped. Logic circuitry 301 preferably comprises a microprocessor controller, such as, but not limited to a Freescale PowerPC microprocessor. In the preferred embodiment of the present invention logic circuitry 301 serves as means for controlling base station 101, and as means for analyzing received message content, and means generating messages that cause relay stations 102 to cease transmission. Transmit and receive circuitry 302-303 are common circuitry known in the art for communication utilizing a well known network protocols, and serve as means for transmitting and receiving messages. For example, transmitter 302 and receiver 303 are well known IEEE 802.16 transmitters and receivers that utilize the IEEE 802.16 network protocol. Other possible transmitters and receivers include, but are not limited to transceivers utilizing Bluetooth, IEEE 802.11, or HyperLAN protocols.

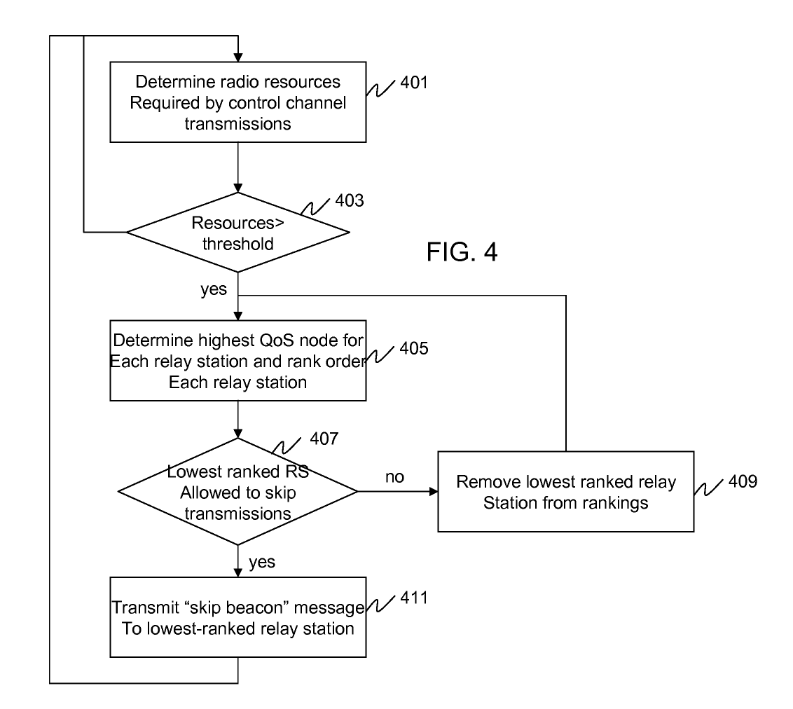

FIG. 4 is a flow chart showing operation of base station 101. The logic flow begins at step 401 where logic circuitry 301 determines the radio resources required by control channel/beacon transmissions of base station 101 and relay stations 102. At step 403, logic circuitry determines if the resources required by all control channel transmissions is greater than a threshold (e.g., a percentage of radio resource capacity). If at step 403 it is determined that the total resources required is less than or equal to the threshold, the logic flow returns to step 401, otherwise the logic flow continues to step 405. At step 405, logic circuitry accesses storage 304 to determine a highest quality of service mobile stations being served by each relay station 102 and rank orders the relay stations 102 based on the highest quality of service mobile stations served by each station 102. As discussed above, the mobile stations may be ranked based on other criteria, such as, but not limited to a quality of service required by connected mobile stations, a number of registered mobile stations, on a probability to relay communications between a base station and a mobile station, a probability to have a new registration of mobile stations, . . . , etc.

Continuing, the logic flow continues to step 407 where logic circuitry 301 determines if the lowest-ranked relay station 102 is allowed to skip a control channel broadcast (beacon broadcast). As discussed above, no relay station 102 is allowed to skip more than a predetermined number (e.g., 2) beacon broadcasts. Thus, if at step 407 it is determined that the lowest-ranked relay station 102 cannot have its beacon skipped, the relay station is removed from the list of ranked relay stations (step 409) and the logic flow returns to step 405. This allows for only relay stations allowed to skip beacon transmissions to be instructed to do so.

If, however, at step 407 it is determined that the lowest-ranked relay station 102 is allowed to skip its beacon, then the logic flow continues to step 411 where logic circuitry 301 instructs transmitter 302 to transmit a “skip beacon” message to the lowest-ranked relay station and the logic flow returns to step 401. Alternatively, a “skip beacon” message may be transmitted to more than one relay station, instructing the lowest ranked relay stations to cease beacon transmission.

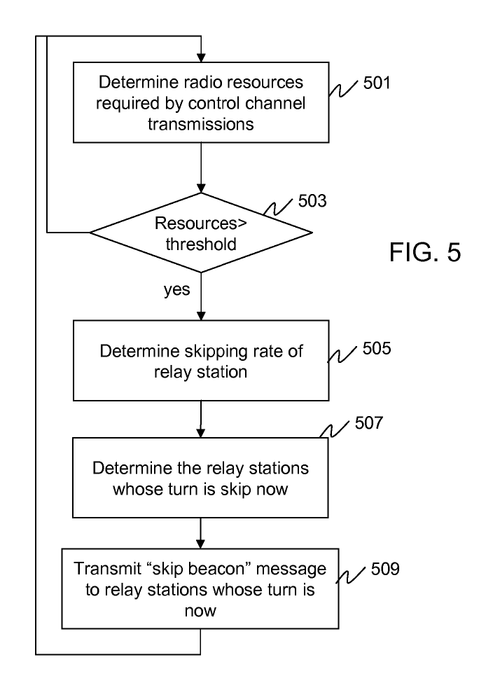

While the above logic flow described ranking relay stations and skipping transmissions for relay stations having a lower rank, in an alternate embodiment of the present invention transmissions from all relay stations may be skipped without ranking. Similarly, all relay stations may be ranked the same order, and thus will all need to be skipped periodically. This is shown in the logic flow of FIG. 5.

The logic flow begins at step 501 where logic circuitry 301 determines the radio resources required by control channel transmissions of base station 101 and relay stations 102. At step 503, logic circuitry determines if the resources required by all control channel transmissions is greater than a threshold (e.g., 50%). If at step 503 it is determined that the total resources required is less than or equal to the threshold, the logic flow returns to step 501, otherwise the logic flow continues to step 505. At step 505, logic circuitry 301 determines the skipping rate of control channel transmission from relay stations 102. For example, the step of determining the skipping rate may comprise the step of determining a percentage of beacon transmissions each node will need to skip to bring the resources required by beacon transmissions below the threshold. At step 505, logic circuitry 301 will determine this percentage.

The logic flow continuous to step 507 where logic circuitry 301 accesses storage 304 to determine the relay stations whose turn it is to skip a control channel broadcast now based on the skipping rate and previous beacon skipped information. For example, if there are four relay stations broadcasting control information, to reduce control channel transmissions by 25%, one relay station will need to be skipped per frame. Logic circuitry 301 instructs transmitter 302 to transmit a “skip beacon” message to the relay stations whose turn is to skip (step 509) and the flow returns to step 501.

While the invention has been particularly shown and described with reference to a particular embodiment, it will be understood by those skilled in the art that various changes in form and details may be made therein without departing from the spirit and scope of the invention. For example, if a base station determines the ranking among the active relay stations as equal, then the base station may skip transmitting control message transmission from relay stations equally among the similarly-ranked relay stations. It is intended that such changes come within the scope of the following claims.

1. A method for beacon transmission, the method comprising the steps of:
determining resources required by beacon transmissions;
determining if the resources required exceeds a threshold;
rank ordering relay stations; and
instructing a relay station having a low rank to cease beacon transmission.

2. The method of claim 1 wherein the step of determining the resources required by beacon transmissions comprises the step of determining how much radio resources are required by beacon transmissions.

3. The method of claim 2 wherein the step of determining if the resources required exceeds the threshold comprises the step of determining if a percentage of radio resource capacity used by beacon transmissions exceeds a percentage of radio resource capacity.

4. The method of claim 1 wherein the step of rank ordering relay stations comprises the step of rank ordering the relay stations based on a quality of service required by connected mobile stations.

5. The method of claim 1 wherein the step of rank ordering relay stations comprises the step of rank ordering the relay stations based on a number of registered mobile stations.

6. The method of claim 1 wherein the step of rank ordering relay stations comprises the step of rank ordering the relay stations based on a probability to relay communications between a base station and a mobile station.

7. The method of claim 1 wherein the step of rank ordering relay stations comprises the step of rank ordering the relay stations based on a probability to have a new registration of mobile stations.

8. The method of claim 1 further comprising the steps of:
determining if a lowest-ranked relay station is allowed to skip beacon transmissions; and
wherein the step of instructing relay stations having a low rank to cease beacon transmission comprises the step of instructing only relay stations allowed to skip beacon transmissions.

9. A method for beacon transmission, the method comprising the steps of:
determining resources required by beacon transmissions;
determining if the resources required exceeds a threshold;
determining a skipping rate for relay stations; and
instructing relay stations to cease beacon transmission based on the skipping rate.

10. The method of claim 9 wherein the step of determining the skipping rate comprises the step of determining a percentage of beacon transmissions each node will need to skip to bring the resources required by beacon transmissions below the threshold.

11. The method of claim 9 wherein the step of determining the resources required by beacon transmissions comprises the step of determining how much radio resources are required by beacon transmissions.

12. The method of claim 11 wherein the step of determining if the resources required exceeds the threshold comprises the step of determining if a percentage of radio resource capacity used by beacon transmissions exceeds a percentage of radio resource capacity.

13. An apparatus comprising:
logic circuitry determining resources required by beacon transmissions, determining if the resources required exceeds a threshold, rank ordering relay stations; and
a transmitter instructing a relay station having a low rank to cease beacon transmission.

14. The apparatus of claim 13 wherein the resources required by beacon transmissions comprises how much radio resources are required by beacon transmissions.

15. The method of claim 14 wherein the logic circuitry determines if a percentage of radio resource capacity used by beacon transmissions exceeds a percentage of radio resource capacity.

16. The apparatus of claim 13 wherein the rank ordering of relay stations comprises rank ordering the relay stations based on a quality of service required by connected mobile stations.

17. The apparatus of claim 13 wherein the rank ordering of relay stations comprises the rank ordering the relay stations based on a number of registered mobile stations.

18. The apparatus of claim 13 wherein the rank ordering of relay stations comprises rank ordering the relay stations based on a probability to relay communications between a base station and a mobile station.

19. The apparatus of claim 13 wherein the rank ordering of relay stations comprises the rank ordering relay stations based on a probability to have a new registration of mobile stations.

20. The apparatus of claim 13 wherein the logic circuitry further determines if a lowest-ranked relay station is allowed to skip beacon transmissions.
